(19) United States
(12) Patent Application Publication
(10) Pub. No.: US 2026/0116791 A1
(43) Pub. Date: Apr. 30, 2026

(54) MASS TRANSFER ENHANCER DEVICE FOR CHEMICAL REACTORS OPERATING WITH FLUIDS

(71) Applicant: Viridis Research Inc., Vancouver (CA)

(72) Inventors: Macarena A. CATALDO-HERNANDEZ, Vancouver (CA); John Ryan FAJALONGO, Vancouver (CA); Joel Ezequiel HERNANDEZ BALADES, Vancouver (CA)

(21) Appl. No.: 19/343,921

(22) Filed: Sep. 29, 2025

Related U.S. Application Data
(60) Provisional application No. 63/714,164, filed on Oct. 31, 2024.

(51) Int. Cl. C02F 1/467; C02F 103/00

(52) U.S. Cl. CPC C02F 1/4672; C02F 2103/002; C02F 2209/40; C02F 2301/022

(57) ABSTRACT

According to embodiments, an improved apparatus and methods of use are provided for the removal and degradation of contaminants from a fluid stream, the apparatus comprising an electrochemical cell having at least one electrode and at least one helicoidal baffle positioned within a fluid path of the cell. The helicoidal baffle may be configured to guide fluid flow along its axis, generating turbulent vortices that disrupt the diffusion layer at the electrode—electrolyte interface, increase mass transport, and enhance reaction rates. Parameters of the helicoidal baffle, including diameter, number of fins, fin thickness, revolutions per unit length, and meridian profile shape, may be controlled to optimize performance. The apparatus may further operate to generate oxidizing agents by electro-oxidative reactions, thereby degrading contaminants in the fluid stream and discharging a treated effluent.

### CROSS REFERENCE TO RELATED APPLICATIONS

This application claims the benefit of priority to U.S. Provisional Ser. No. 63/714,164 filed Oct. 31, 2024, entitled “MASS TRANSFER ENHANCER DEVICE FOR CHEMICAL REACTORS OPERATING WITH FLUIDS”, which is specifically incorporated by reference herein for all that it discloses or teaches.

### FIELD

Embodiments relate to improved systems and methods for chemical reactors operating at solid-fluid boundaries, including solid-liquid, solid-gas, and solid-liquid- gas interfaces where diffusion layers form. Specifically, embodiments concern the treatment of fluids such as water, wastewater, and greywater, with emphasis on optimizing vortex assisted mass transport parameters in electrochemical reactors.

### BACKGROUND

Organic pollutants such as pesticides, dyes, pharmaceutical compounds, microplastics (MPs), and biofilms are increasingly pervasive in aquatic ecosystems, in large part due to the growth of plastic production. It is estimated that seventy one percent of plastic waste is absorbed directly into the environment, and that nearly 8 million metric tons of plastic waste mix with the marine ecosystem each year. This number is projected to rise more than fourfold by 2050.

Greywater and wastewater act as major carriers of microplastics, including microbeads and microfibers, which together account for more than sixty percent of total global microplastic pollution. Most ship based greywater treatment systems and land based wastewater treatment plants are unable to successfully remove these pollutants from their effluent streams.

A range of treatment strategies have been attempted, yet they remain limited. Physical separation methods such as adsorption, biofilters, bioreactors, biologically active filters, and membrane filtration can trap organic compounds based on size and other characteristics. However, these approaches often exhibit low efficiency, depend heavily on the type and properties of the compounds, and suffer from fouling and short service life. Membranes that incorporate catalysts may chemically bind pollutants but only retain them for short periods, decreasing lifetime. In addition, most membrane based systems only capture pollutants, leaving additional processing necessary to degrade the retained fragments.

Oxidative degradation techniques, including electrochemical oxidation, can achieve rapid and non-selective oxidation of organic compounds. Electrochemical systems typically operate either through direct oxidation of compounds on the anode surface or through indirect oxidation via in situ generation of oxidizing species such as hydroxyl radicals, chlorine species, oxygen, perchlorate, ozone, hydrogen peroxide, or hypochlorite. A variety of electrochemical cell configurations have been developed for these approaches, including parallel plates, divided chambers, packed bed electrodes, stacked discs, concentric cylinders, moving bed electrodes, and filter press arrangements.

Despite these efforts, common limitations remain across known electrochemical systems. Operational efficiency is generally poor, leading to high energy consumption and low contaminant oxidation rates. Electrodes often have a short lifetime, particularly where sacrificial anodes are employed, resulting in increased replacement costs. The low ionic conductivity of wastewater requires the addition of supporting electrolytes in significant concentrations to obtain reasonable cell voltages. Such additives, including anolytes and catholytes with high base concentrations or pH values, can result in effluents that fail to meet contamination or discharge standards, increasing both treatment and disposal costs.

Additional design inefficiencies further limit performance. Large electrode gaps and low surface area electrodes reduce contaminant removal rates. Slow mass transport within porous beds, non-optimized catalyst materials with poor reaction kinetics, and the need for high electrode overpotentials contribute to energy losses. These conditions often demand large and complex reactor systems. Moreover, many oxidative electrochemical treatments require additional chemicals or oxygen feed, which can generate secondary pollution, add costs, and introduce byproducts that may be hazardous to the environment.

Despite many attempts to improve wastewater treatment technologies, significant challenges remain. There is a continuing need for improved systems and methods capable of effectively and efficiently removing organic pollutants from wastewater and greywater streams.

### SUMMARY

According to embodiments, an apparatus and method of use for the removal and degradation of at least one contaminant from a fluid stream are provided. In some embodiments, the apparatus may provide at least one surface defining a solid-fluid boundary, at least one inlet for receiving at least a portion of the fluid stream as an input fluid stream, at least one outlet for discharging at least a portion of the fluid stream as an output fluid stream, the fluid stream passing from the at least one inlet to the at least one outlet forming at least one fluid path, and at least one helicoidal baffle, positioned proximate to the at least one surface and within the at least one fluid path, the at least one helicoidal baffle for directing the at least one fluid stream to generate a vortex in the fluid stream flowing along the at least one fluid path, disrupting a diffusion layer near the solid-fluid boundary.

In some embodiments, the apparatus may comprise a chemical reactor cell. In some embodiments, the chemical reactor cell may comprise an electrochemical cell operative to generate at least one oxidizing agent by electro-oxidative reactions. In some embodiments, the electrochemical cell may comprise at least one electrode pair and at least one electrolyte, and wherein a diffusion layer is present at an interface between each electrode of the pair and the electrolyte.

In some embodiments, the at least one helicoidal baffle may have a diameter configured to define a predetermined gap.

In some embodiments, the at least one helicoidal baffle may comprise at least one helicoid defined by a profile curve.

In some embodiments, the at least one helicoidal baffle may comprise at least one fin, the fin having a predetermined meridian thickness.

In some embodiments, the at least one helicoidal baffle may be configured with a handedness, the handedness comprising a right-handed helicoid or a left-handed helicoid. In some embodiments, the apparatus may comprise at least two helicoidal baffles, the at least two helicoidal baffles being mirrored in pattern to have alternating handedness.

According to embodiments, an apparatus and methods of use for removing and degrading at least one contaminant from a fluid stream are provided. In some embodiments, the methods comprise introducing at least a portion of the fluid stream along at least one fluid path within an apparatus, the apparatus forming at least one surface defining a solid-fluid boundary, and having at least one inlet for receiving the portion of the fluid stream as an input fluid stream, at least one outlet for discharging the portion of the fluid stream as an output fluid stream, and at least one helicoidal baffle positioned within the at least one fluid path and proximate to the at least one surface, directing the at least one input fluid stream along the at least one helicoidal baffle to generate a vortex in the fluid stream, disrupting a diffusion layer at the at least one solid-fluid boundary, and operating the apparatus to degrade the at least one contaminant, and discharging at least a portion of the fluid stream from the apparatus as the output fluid stream.

In some embodiments, the solid-fluid boundary may comprise an interface between at least one electrode surface and at least one electrolyte within the apparatus.

In some embodiments, the at least one helicoidal baffle may comprise a diameter defining a predetermined gap.

In some embodiments, the at least one helicoidal baffle may form at least one helicoid defined by a profile curve.

In some embodiments, the fluid stream along the at least one helicoidal baffle may comprise directing the fluid through at least one helical channel having openings.

In some embodiments, the at least one helicoidal baffle may be configured with a handedness, the handedness comprising a right-handed helicoid or a left-handed helicoid.

In some embodiments, introducing the fluid stream may comprise controlling the flow rate to promote turbulence and enhance mixing at the solid fluid boundary.

According to embodiments, the use an apparatus for removing and degrading at least one contaminant from the fluid stream is provided, the apparatus having at least one inlet for receiving a fluid stream, at least one outlet for discharging the fluid stream, and at least one helicoidal baffle positioned proximate to a surface defining a solid-fluid boundary and within a fluid path, the at least one helicoidal baffle directing the fluid stream to generate a vortex that disrupts a diffusion layer at the solid-fluid boundary.

In some embodiments, the apparatus being used may comprise a chemical reactor cell. In some embodiments, the apparatus may further comprise an electrochemical cell operative to generate at least one oxidizing agent at the solid-fluid boundary. In some embodiments, the electrochemical cell may comprise at least one electrode pair and at least one electrolyte, and wherein a diffusion layer is present at an interface between each electrode of the pair and the electrolyte.

### BRIEF DESCRIPTION OF THE DRAWINGS

Embodiments of the present embodiments will now be described, by way of example only, with reference to the attached Figures.

FIG. 1 shows a perspective side view of an example embodiment of the presently improved apparatus, the example showing an example chemical reactor (e.g., an example electrochemical cell being depicted), according to embodiments;

FIG. 2 shows an example helicoidal-shaped baffle array of the electrochemical cell of FIG. 1, according to embodiments;

FIG. 3A shows a representative diagram illustrating an example physical distance or ‘gap’ between electrodes (e.g., cathode↔anode↔cathode) of the electrochemical cell of FIG. 1, according to embodiments;

FIG. 3B shows corresponding representative diagram (L) and side perspective views (R) of the helicoidal baffle of FIG. 2, FIGS. 3A and 3B collectively referred to as FIG. 3, according to embodiments;

FIG. 4 provides side perspective views of example alternative embodiments of the helicoidal baffle of FIG. 2, the alternative embodiments having a single fin (a), double fin (b), triple fin (c), and quadruple fin (d) corresponding to their meridians, according to embodiments;

FIG. 5 provides a bottom perspective view of the helicoidal-shaped baffle of FIG. 2, according to embodiments;

FIG. 6 provides a side perspective view of an example configuration of the at least one helicoidal shaped baffle of FIG. 2, the at least one baffles configured to be mirrored in pattern, according to embodiments;

FIG. 7A shows a side perspective view of another example configuration of the at least one helicoidal shaped baffle of FIG. 2, the at least one baffles forming contained fluid channels, according to embodiments; and

FIG. 7B shows a wire frame side perspective view the example configuration shown in FIG. 7A, the example configuration having hidden lines shown for illustrative purposes only according to embodiments; and

FIG. 7C shows a schematic representation of fluid flow through the contained fluid channels formed in the example at least one helicoidal baffle shown in FIG. 7A, according to embodiments.

### DETAILED DESCRIPTION OF THE PREFERRED EMBODIMENTS

According to embodiments, an improved apparatus and methods for the removal and degradation of at least one contaminant from a fluid stream are provided. Herein, while a primary embodiment of the apparatus is described as an electrochemical cell, this is provided for illustrative purposes only, and any form of chemical reactor system configured to contain and control a chemical reaction under specific conditions is also contemplated.

In some embodiments, the present apparatus may comprise at least one helicoidal baffle positioned within the fluid path of the contaminated fluid stream, such baffle serving to generate turbulent vortices in the flowing fluid. In some embodiments, an array of helicoidal baffles may be provided at or near a solid-fluid boundary within the apparatus, such boundary or interface between, for example, an electrode surface and an electrolyte in an electrochemical cell. As will be described, each helicoidal baffle may be defined by operational parameters including, without limitation, one or more of meridian dimensions and shape, axis location relative to the meridian, pitch, handedness, and taper, such parameters advantageously selected to enhance vortical flow for improving mass transfer to the solid surface.

According to embodiments, the presently improved apparatus and method of use may comprise at least one helicoidal baffle having optimized geometrical parameters, such parameters specifically selected to maximize reactor performance at the solid-fluid boundary. For example, without limitation, such optimized parameters may be specifically selected to disrupt the diffusion layer at the solid-fluid interface, to enhance bulk mixing, and/or to assist in the removal of bubbles produced during reactions.

In some embodiments, each helicoidal baffle of the presently improved apparatus and methods of use may form a helix having a central axis collinear with the velocity vector of the fluid flow. In other contemplated embodiments, the central axis of the helix may be non-collinear with the velocity vector of the fluid flow, for example being oriented at an angle thereto, so as to induce additional turbulence, mixing, or flow redirection within the fluid stream. In each case, it is contemplated that the at least one baffle may be configured to direct the fluid stream along a flow path through the apparatus so as to generate vortices in the fluid, such vortices being sufficient to disrupt the diffusion layer at the solid-fluid boundary.

In some embodiments, the present apparatus and methods of use may be configured such that each of the at least one baffles may be positioned at or proximate the solid-fluid boundary, which in some cases may lie between a pair of solid surfaces, ensuring that turbulence is generated precisely where mass transport limitations occur. In some cases, aligning the vortical flow with the velocity vector may serve to reduce potential energy losses associated with redirecting the fluid stream.

In some embodiments, the turbulent fluid flow created by the at least one helicoidal baffle may, advantageously, promote dispersion of compounds formed at the solid-fluid boundary into the bulk fluid, enhancing mixing and preventing stagnation of the fluid. Turbulent fluid flow may further mitigate bubble formation during reactions, where bubbles adhering to the solid surface would otherwise block active sites. In some embodiments, advantageously, turbulent fluid flow may break bubbles into smaller sizes that may be carried away by the flow, maintaining effective fluid-solid contact.

In some embodiments, the present apparatus and methods of use may serve to enhance oxidative degradation processes, particularly electrochemical oxidation. In some embodiments, the present apparatus may comprise at least one electrochemical cell configured for electrochemical oxidation through direct oxidation of compounds at the anode surface and through indirect oxidation where the anode generates reactive species such as, without limitation, hydroxyl, chlorine, oxygen, or perchlorate radicals, or compounds including hypochlorite, ozone, or hydrogen peroxide. In such embodiments, once formed at the anode surface, these species diffuse into the bulk fluid and oxidize organic contaminants, treating the fluid stream.

According to embodiments, the presently improved apparatus and methods of use may comprise optimized geometry and placement of at least one helicoidal baffle, ensuring that vortices generated in the fluid stream are of sufficient intensity to improve mass transport while preserving conditions favourable for the desired reaction rate. Without being limited to theory, such optimized vortex formation at the fluid-solid boundary may prevent stagnation, promote the incorporation of reaction products into the bulk fluid, improving both reaction efficiency and heat transfer within the system. Any of the optimization parameters described herein may be implemented individually or in combination to achieve the desired effect.

Certain terminology may be used in the present description and is intended to be interpreted according to the definitions provided below.

Herein, the terms ‘contaminant(s)’ and/or ‘pollutant(s)’ are used interchangeably to mean any molecule, cell, or particulate to be removed from a fluid stream including, without limitation, dissolved, suspended and/or solid compounds including organic compounds such as microplastics, microfibers, pesticides, dyes, pharmaceuticals, and/or biofilms. In some embodiments, at least a portion of the fluid stream may comprise greywater and/or wastewater. In other embodiments, at least a portion of the fluid stream may comprise water for water purification.

Herein, the terms ‘greywater’ or ‘wastewater’ are used interchangeably to mean urban and domestic wastewater commonly generated in households, office or industrial buildings, ships, aircraft, and vehicles from sinks, showers, baths, and washing machines or dishwashers (i.e., all urban and domestic fluid streams excluding the wastewater from toilets, or that contain fecal matter).

Herein, the terms ‘microplastic(s)’, ‘MPs’, or ‘microbeads’are used to mean solid form pollutants found in various fluids in the environment, including wastewater, having various dimensions, structures, densities, colours, and types of polymers. Microplastics can be generally categorized morphologically as fiber, sphere, foam, sheet, fragment, and film, or combinations of the same, with microfibers being most commonly detected in the environment. Microplastics may also be colloidally suspended within a fluid as dispersed insoluble particles or suspended as larger aggregates.

Herein, ‘microfibers’is used to mean microplastic fibers having average concentrations and sizes in water ranging from 0.02-25.8 fibers/L and 0.09-27.06 mm, respectively. Garment industries are a primary source of microfibers in the environment, where microfibers are produced during various stages of garment washing and released with wastewater from such processes as washing effluent. As such, fiber-shaped microplastics are increasingly found in the environment from the mounting discharge of the clothing industry, both industrial and residential, and through further fragmentation that can occur through the process of weathering.

Herein, ‘dyes’ is used to mean the dyeing solution employed in a dyeing process composed of dyes, mordants, fixatives, detergents, and any other chemical compound or solvent used for dyeing, improving the dyeing process, or removing the excess dye. A dye may include a compound that chemically bonds to a substrate with the intention of modifying its visible appearance and color, with most dyes being organic compounds. To improve color fastness, dyeing processes utilize other compounds that help the dye to fix onto the desired substrate. The dyeing process can also include subsequent washings or rinsings of the dyed substrate to remove excess and to apply a finishing step to the substrate, resulting in a dyeing residue that includes other compounds besides just dyes.

Herein, ‘oxidizing radicals’, ‘oxidative species’, ‘oxidative agents’, and ‘oxidative products’ means any species or substance operative as an oxidizer, i.e., having the ability to oxidize another substance.

Herein, ‘helicoid’, ‘helicoids’, ‘helicoidal’ are used to refer to the shape given to baffles which corresponds to that of a generalized helicoid surface, which is created by rotating and simultaneously displacing a curve profile along the helicoid's axis.

Herein, ‘meridian’ refers to the profile or shape being rotated and translated around an axis to form a helicoid. In some cases, meridian and cross-sectional shapes will be identical, but this is not a requirement for a helicoid.

Herein, ‘diameter’, ‘helicoid diameter’ refers to the diameter of the circle that circumscribes the helicoid's shape when seen along its axis, the center of such a circle intersecting with the helicoid's axis and on the same plane as the plane normal to the helicoid's axis.

Herein, ‘handedness’describes the direction of rotation of the helicoid, which can be ‘right-handed’ (RH) or ‘left-handed’ (LH). This can be identified by looking at the helicoid along its axis and rotating it clockwise; if the helicoid appears to move away from the observer, it is right-handed, whereas if it appears to move toward the observer, it is left-handed. By way of analogy, handedness may also be described using the human hand: when the fingers of the right hand curl in the direction of the helical rotation, the thumb points along the axis of a right-handed helicoid; conversely, when the fingers of the left hand curl in the direction of the helical rotation, the thumb points along the axis of a left-handed helicoid.

Herein, the terms “pitch,” “revolutions per centimeter,” and “rev/cm” refer to the number of rotations completed by the meridian over a unit length of translation (e.g., such unit length, in some cases, being one centimeter).

Herein, ‘fin’ refers to the surfaces on the helicoidal baffles that interact and redirect the fluid to form vortices. Their shapes and number are directly related to the shape of the meridian since the fins are formed as the meridian is rotated and translated along the helicoid's axis.

Each term used and defined herein is for explanatory purposes only and in no way is intended to limit the scope of the technology.

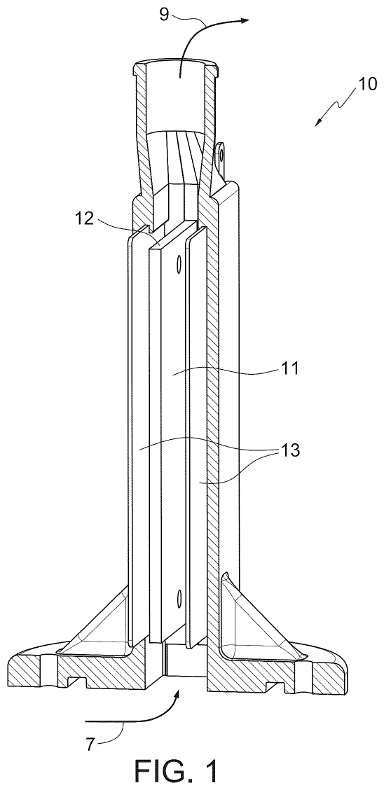

The presently improved optimization parameters will now be described having regard to FIG. 1-7.

According to embodiments, having regard to FIG. 1, an example embodiment of the presently improved apparatus 10 and methods of use for removing and degrading at least one contaminant from a fluid stream are provided. Apparatus may comprise any suitable chemical reactor cell known in the industry for use in removing and degrading at least one contaminant from a fluid stream, including organic compounds from water, greywater, wastewater and the like.

For example, such systems may be similar to those described in International Patent Application No. PCT/CA2022/050375, incorporated herein in its entirety by reference. In such embodiments, electrochemical cells 10 typically comprise at least one electrode 12 having at least one anode 11 and at least one cathode 13. At least a portion of a fluid to be treated is introduced into cell 10 through at least one inlet 7 as an input fluid stream. Within cell 10, at least a portion of the fluid passes into contact with the electrode 12, where at least one contaminant within the fluid may be captured and degraded electrochemically, for example through the generation of at least one oxidizing agent. Following treatment, a portion of the fluid stream may be discharged from cell 10 through at least one outlet 9 as an output fluid stream.

In some embodiments, the optimization parameters of the presently improved system and methods of use may serve to enhance oxidation of a bulk solution, providing rapid oxidation of at least one contaminant. In some embodiments, the optimization parameters of the presently improved system may be used with known electrochemical cells for use in wastewater treatment including, for example, regenerative cells operative as self-cleaning units for oxidizing compounds of all size, shape, and type.

In one illustrative embodiment, the presently improved apparatus 10 may comprise an electrochemical cell, having at least one electrode 12 and at least one electrolyte. Apparatus 10 may have a diffusion layer at an interface between the at least one electrode 12 and the at least one electrolyte, with a solid-fluid boundary formed therebetween. In operation, where apparatus 10 may generate at least one oxidizing agent generated by electro-oxidative reactions, apparatus 10 may be configured to enhance such reactions by, at least, disrupting a diffusion layer at the solid-fluid boundary. For example, according to embodiments, operation parameters of apparatus 10 may be optimized by controllably generating fluid vortices in the fluid stream.

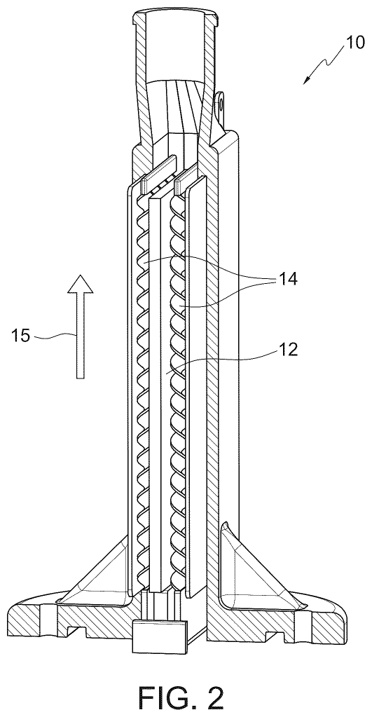

In some embodiments, having regard FIG. 2, apparatus 10 comprise at least one baffle 14 positioned within cell 10 and configured to guide the fluid stream introduced into apparatus 10. In some embodiments, without limitation, the at least one baffle 14 may form a helix or helicoidal-shaped, serving to maximize vorticity at the solid-fluid boundary.

For example, in some embodiments, at least a portion of input fluid stream may be directed to flow along a path extending from a first end towards a second end of baffle 14 (e.g., arrow 15). Without limitation, fluid path 15 may serve to enhance the generation of vortices in the fluid, disrupting the stagnant diffusion layer and breaking down bubbles adhering to the surface of electrode 12. In this manner, apparatus 10 may be configured to enhance reaction rates.

In some embodiments, having regard to FIG. 2, the at least one baffle 14 may be positioned within apparatus 10 at or near a surface of electrode 12 and configured to generate vortices in the fluid stream as the stream flows across electrode 12. For example, in operation, directing the fluid stream along at least one helicoidal baffle 14 serves to maximize vorticity at electrode 12 surface, maintaining efficient fluid-solid interaction.

In some embodiments, without limitation, it is contemplated that the at least one baffle 14 may be manufactured from any suitable material, including by additive manufacturing technologies such as 3D printing. In some embodiments, one or both of an anode 11 and cathode 13 of electrode 12 may themselves be formed into a helicoidal shape, such that electrode 12 comprises or incorporates a helicoidal baffle 14.

The selection of material for baffle 14 may be based on factors such as electrical conductivity, chemical resistance, mechanical strength, and compatibility with the electrolyte or contaminants being treated. For example, in some embodiments, the at least one baffle 14 may be fabricated from inert polymeric materials, conductive composites, or metal alloys resistant to corrosion in electrochemical environments. In other embodiments, the helicoidal baffle 14 may be coated or surface-treated to further enhance durability, catalytic activity, or fouling resistance. In further embodiments, adjacent helicoidal baffles 14 may be aligned and connected along at least a portion of their edges to provide structural stabilization and preserve desired spacing and orientation. The ability to fabricate helicoidal geometries directly into the structure of electrode 12, or as separate modular components, may provide design flexibility, facilitate assembly, and allow replacement or customization of baffle 14 to optimize performance under different operating conditions.

In some embodiments, as will be described in more detail herein, various parameters of the at least one helicoidal baffle 14 may be specifically designed to optimize vortex formation in the fluid input stream, optimizing its treatment within electrochemical cell 10. For example, such parameters of baffle 14 may include, without limitation, a circumscribed diameter, meridian shape and number of fins, fin thickness, number and configuration, or any combination thereof.

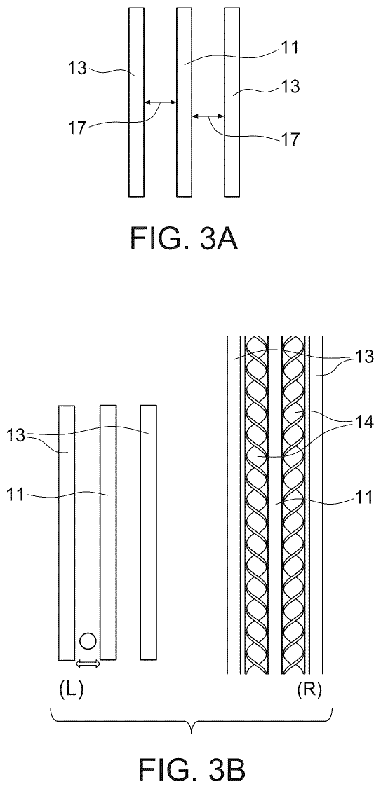

According to embodiments, apparatus 10 and methods of use may provide at least one helicoidal baffle 14 with controlled parameters operative influence vortex generation in the fluid stream. One such parameter is the diameter of the at least one helicoidal baffle 14. For example, as illustrated in FIG. 3B, vortex generation in the fluid stream directed along the at least one baffle 14 may enhanced by optimizing the physical distance, or “gap” 17 (FIG. 3A), between electrodes 12 and the helicoidal baffle 14 disposed therebetween (for example, between anode 11 and cathode 13, where arrows 17 indicate the cathode↔anode↔cathode spacing, or gap).

In some embodiments, the diameter of the at least one helicoidal baffle 14 may be specifically selected to establish an optimized gap 11, tailored to the desired reaction parameters and subject to a predetermined tolerance (e.g., for assembly). In further embodiments, as above, one helicoidal baffle 14 may be structurally stabilized by being aligned with and connected along at least a portion of its edge to an adjacent helicoidal baffle, thereby improving rigidity and maintaining the desired spacing and orientation of the helicoids during operation.

For example, without limitation, cell 10 may include at least one helicoidal baffle 14 having a diameter in the range of approximately 3 mm to 9 mm, which may provide a gap 11 of at least 10 mm. In other embodiments, the diameter of helicoidal baffle 14 may be configured to achieve the smallest possible tolerance relative to the anode 11, thereby maximizing vorticity in the fluid stream.

For example, vortical fluid flow through cell 10 was evaluated using helical baffles 14 having different diameters under identical flow conditions (e.g., flow of 8 L/min at one revolution per centimeter). It was observed that a baffle diameter of approximately 3 mm produced weaker vortices, whereas a baffle diameter of approximately 9 mm produced stronger, more effective vortices. In such embodiments, optimizing baffle diameter serves to significantly enhance vortex generation within apparatus 10.

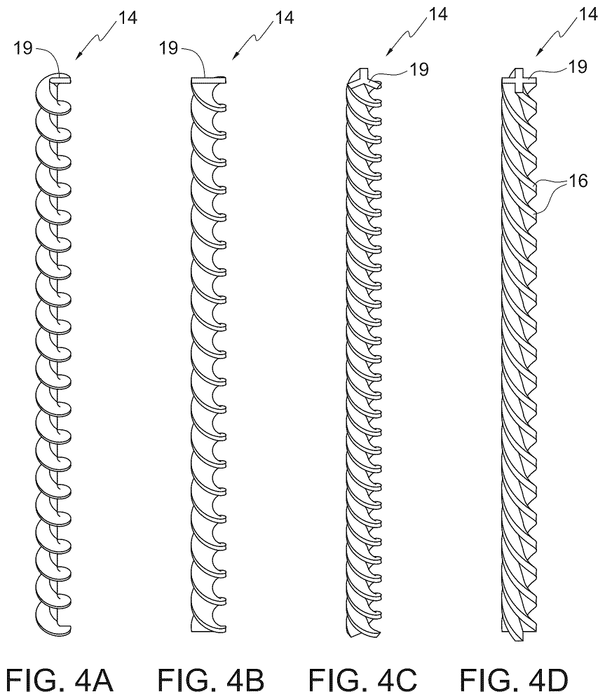

Herein, without limitation, the diameter of helicoidal baffle 14 may be optimized to provide the largest possible gap 11 between the anode and cathode of electrode 12 (accounting for assembly tolerances), while maximizing fluid turbulence and minimizing flow resistance. In addition, the diameter of helicoidal baffle 14 may be optimized to contribute to structural stabilization of electrode 12 and serve as a physical spacer for maintaining the desired distance between the cathode and anode. According to embodiments, and with reference to FIG. 4, the apparatus 10 and methods of use may provide at least one helicoidal baffle 14 with controlled parameters operative to influence vortex generation in the fluid stream. One such parameter is the number of fins 16 and the number of rotations per unit length of baffle 14. For example, as illustrated in FIG. 4, each at least one baffle 14 may include a plurality of fins 16 defined by the meridian 19, the meridian shape being a profile curve that is rotated about a central longitudinal axis to form the helicoidal geometry of baffle 14.

In some embodiments, the plurality of fins 16 may be configured to enhance vortex formation in fluid flow. For example, geometrical parameters of fins 16 may be adjusted, including, without limitation, the cross-sectional shape of the meridian profile curve, which determines the number of fins 16 (e.g., single, double, triple, or quadruple), as well as the number of revolutions per unit distance.

For example, vortical fluid flow through apparatus 10 was evaluated using helicoidal baffles 14 comprising a plurality of fins 16. A cross-shaped meridian profile 19 that produced multiple fins 16 generated greater vorticity compared to single-or double-finned 16 structures having higher numbers of revolutions per centimeter. In one evaluation, ten helicoidal baffles 14 with alternating handedness and quadruple fins at 0.5 revolutions per centimeter produced stronger vortical flow compared to double fins at 1 revolution per centimeter under the same flow conditions. It should be understood that, perhaps counterintuitively, a higher number of revolutions per centimeter may not necessarily result in higher vorticity.

In some embodiments, variations in meridian shape 19, such as rounding of the fin edges, may impact the generation of fluid vortices by the at least one helicoidal baffle 14. For example, it was observed that, when fluid flowed through a cell 10 having at least ten helicoidal baffles 14 having double fins 16 (FIG. 4(d)), vorticity decreased when helicoidal baffles 14 comprised slightly rounded edges, as compared to baffles with double fins 16 having straight edges, all other parameters being equal.

Herein, without limitation, the shape of helicoidal baffle 14 may be optimized, for example through a cross-shaped meridian profile 19 or quadruple-fin design with straight edges, to provide the highest level of fluid turbulence while minimizing flow resistance. It should be appreciated that a higher number of revolutions per centimeter may not necessarily correspond to greater vorticity, and that fin 16 geometry may play a greater role in enhancing fluid mixing.

According to embodiments, apparatus 10 and methods of use may provide at least one helicoidal baffle 14 with controlled parameters operative to influence vortex generation in the fluid stream. One such parameter may be the cross-sectional thickness of the fin 16, defining the material dimension of baffle 14. Another parameter may be the pitch of the helix, defining the axial distance over which the fluid is guided around the central axis of the baffle 14 during one complete revolution. These parameters, alone or in combination with other geometrical factors such as meridian profile 19, number of fins 16, handedness, and taper, may be adjusted to optimize vortex intensity, enhance mass transport, and maintain efficient fluid flow within the apparatus 10.

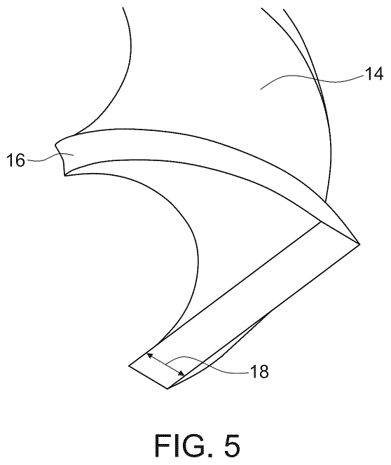

In some embodiments, vortex formation in fluid flowing through electrochemical cell 10 was observed to be influenced by the thickness of fins 16 on helicoidal baffle 14 (i.e., the cross-sectional thickness, 18; FIG. 5). For example, providing thicker fins 16, such as within a range of approximately 0.5 mm to 2 mm may slightly increase vorticity at anode 11 by reducing the cross-sectional area available for fluid flow, thereby increasing velocity at the surface of the electrode 12. In some cases, it was observed that helicoidal baffles 14 with fin thicknesses 18 of approximately 2 mm produced greater vorticity compared to helicoidal baffles 14 with fin thicknesses 18 of approximately 0.5 mm, under otherwise identical operating conditions (e.g., including, without limitation, a fluid flow of 8 L/min and a pitch of 1 revolution per centimeter). In some embodiments, helicoidal baffle 14 thickness 18 may therefore be configured both to enhance vorticity and to ensure electrode 12 remains structurally sound, although any suitable configuration operative to achieve the desired results is contemplated. In this manner, an optimized helicoidal baffle 14 thickness may generate enhanced fluid vortices within cell 10.

Herein, without limitation, fin thickness 18 of helicoidal baffle 14 may be optimized to influence vortex formation within apparatus 10. Thicker fins 16 may reduce the available cross sectional area for fluid flow, thereby increasing velocity at the surface of electrode 12, enhancing vorticity. In addition, selecting an appropriate fin thickness 18 enables apparatus 10 to maximize vortex intensity, minimize diffusion layer stagnation, and improve mass transport to electrode 12 while maintaining stable flow conditions.

According to embodiments, apparatus 10 and methods of use may be configured to provide at least one helicoidal baffle 14 with controlled parameters operative to influence vortex generation in the fluid stream. One such parameter may be the number and positioning of helicoidal baffles 14, for instance, at least two helicoidal baffles 14 mirrored one with the other (e.g., where at least two helicoidal baffles 14 may be mirrored in pattern to have alternating handedness).

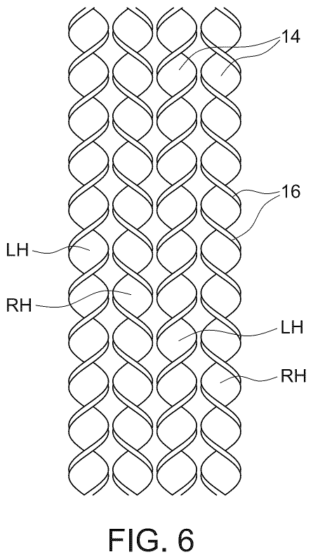

For example, having regard to FIG. 6, improved vortices in fluid flowing through apparatus 10 may be enhanced by optimizing the number of helicoidal baffle(s) 14 (e.g., surface area for fluid flow) as well as the positioning and configuration thereof, e.g., arranged in alternating handedness (left-hand, right-hand, left-hand, etc.) of the at least one helicoidal baffle 14.

In some embodiments, the at least one helicoidal baffle(s) 14 may be configured so as to be mirrored in pattern. In some embodiments, the at least one helicoidal baffle(s) may be longer in length (e.g., by 5-20 mm) than electrode 12 (or electrode pair), and positioned substantially ahead or upstream thereof, to provide uniform vorticity through the surface thereof, although any suitable number and configuration operative to achieve the desired result is contemplated. Notably, the foregoing suggests that higher fluid flow rates may not equate to higher vorticity at the anode and that optimal predetermined flow rates may be necessary for the specific parameter of the cell 10.

In some embodiments, the number of helicoidal baffles 14 may be configured to enable a higher vorticity, wherein a maximum number of helicoidal baffles 14 may produce the highest vorticity. For example, without limitation, apparatus 10 may comprise a maximum number of helicoidal baffles 14, wherein a minimum distance between helicoidal baffles 14 may provide a maximum vorticity at electrode 12 (e.g., at anode), although any suitable configuration operative to achieve the desired results is contemplated.

In some embodiments, vortical fluid flow through apparatus 10 was observed to vary depending on the number of helicoidal baffles 14 provided with alternating handedness (left-hand, right-hand). For example, differences in vorticity were observed between configurations employing five helicoidal baffles 14 with alternating handedness and configurations employing ten helicoidal baffles 14 with alternating handedness, under otherwise identical operating conditions. In this manner, an optimized number of helicoidal baffle(s) 14 may be selected to generate enhanced fluid vortices within apparatus 10.

Herein, without limitation, the optimization of the number and positioning of helicoidal baffles 14 may significantly influence vortex formation within apparatus 10. Increasing the number of baffles 14 can enhance vorticity, particularly when the spacing between baffles 14 is minimized to maximize fluid disturbance at electrode 12. Configurations employing alternating handedness, or mirrored phasing, may further promote uniform vorticity across the surface of electrode 12, while extended baffles 14 positioned upstream of electrode 12 may provide improved flow conditioning. It should also be appreciated that optimal predetermined flow rates in combination with an optimized number and arrangement of baffles 14 may serve to enhance performance (i.e., higher fluid flow rates alone may not achieve greater vorticity).

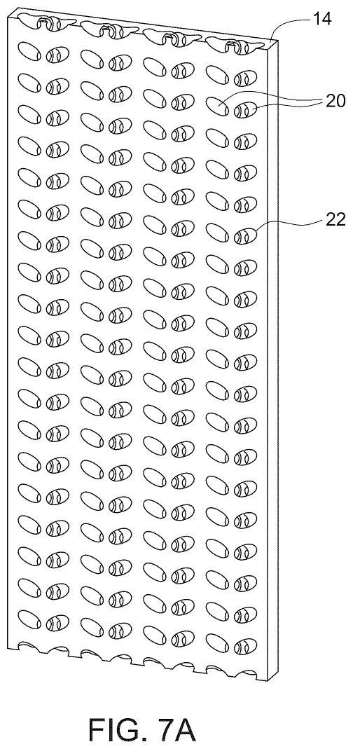

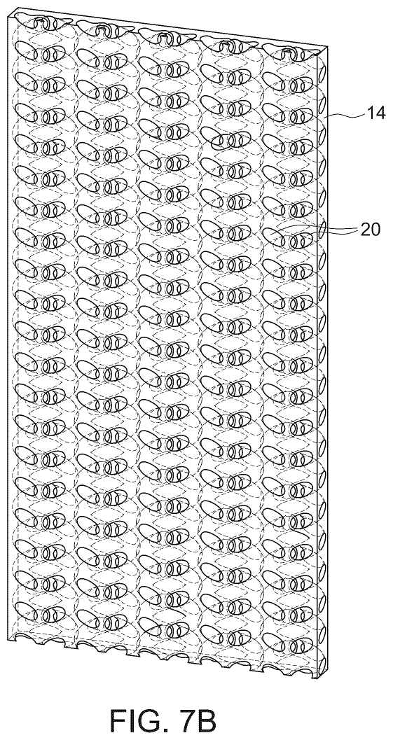

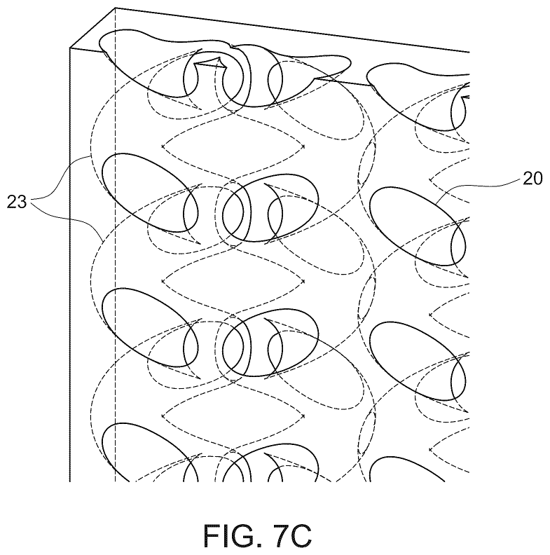

In some embodiments, having regard to FIG. 7A-7C, the at least one helicoidal baffle 14 may be configured to form at least one contained, fluidically distinct channel 20 through which the fluid stream (23, FIG. 7C) travels. The at least one helical channels 20 may include one or more openings 22, openings 22 operative to generate turbulent fluid flow, such as against the surface of electrode 12.

In some embodiments, a plurality of helicoidal-shaped channels 20 may be provided, arranged in alternating directions and fluidically distinct from one another. For example, in some embodiments, at least one helical channel 20 may be configured such that fluid vortices generated in a first helical channel does not counteract fluid vortices generated in one or more second channels.

In some embodiments, the at least one opening 22 of the at least one helical channels 20 may be positioned adjacent one another to promote mixing of the fluid stream, enhancing disruption of the diffusion layer and improving overall mass transport within cell 10. In this manner, an optimized shape or configuration of helicoidal baffle 14 may generate enhanced fluid vortices within cell 10.

Herein, without limitation, the configuration of helicoidal baffles 14 may be optimized to form one or more fluidically distinct helical channels 20, including the placement and orientation of openings 22, to maximize vortex generation and mass transport within apparatus 10. Alternating channel 20 directions may prevent interference between vortices, while openings 22 within each channel 20 may promote mixing of the fluid stream inside that channel 20, thereby enhancing disruption of the diffusion layer at electrode 12. By selecting the number, orientation, and spacing of channels 20 and openings 22, apparatus 10 may be configured to provide high levels of turbulence with minimal flow resistance, thereby improving overall electrochemical performance.

According to embodiments, optimized operation parameters and methods of use are provided for the removal and degradation of at least one contaminant from a fluid stream, including organic compounds from water, greywater, wastewater, and the like. In some embodiments, the presently improved optimization parameters may be used to enhance oxidation of a bulk solution, providing rapid oxidation of at least one contaminant. In some embodiments, the present optimization methods may be used with known electrochemical cells for use in wastewater treatment including, for example, regenerative cells operative as self-cleaning units for oxidizing compounds of all size, shape, and type.

According to embodiments, in some embodiments, the present optimization parameters may serve to enhance the generation of fluid vortices within the electrochemical cell, such vortices being generated to ensure sufficient/ideal turbulence in the fluid flow is created while maintaining/allowing adequate electrochemical resistance thereto. For instance, without being limited to theory, it should be understood that optimizing the vortex generated within an electrochemical cell may serve to enhance the mixing radicals within the bulk solution, thereby enhancing the efficiency of the electrochemical oxidation within the cell. It is contemplated herein that any one of the presently described optimization parameters for improving vortex generation may be used alone or in combination.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and the described portions thereof.

We claim:

1. An apparatus for the removal and degradation of at least one contaminant from a fluid stream, the apparatus providing at least one surface defining a solid-fluid boundary, the apparatus comprising:
at least one inlet for receiving at least a portion of the fluid stream as an input fluid stream,
at least one outlet for discharging at least a portion of the fluid stream as an output fluid stream, the fluid stream passing from the at least one inlet to the at least one outlet forming at least one fluid path, and
at least one helicoidal baffle, positioned proximate to the at least one surface and within the at least one fluid path, the at least one helicoidal baffle for directing the at least one fluid stream to generate a vortex in the fluid stream flowing along the at least one fluid path, disrupting a diffusion layer near the solid-fluid boundary.

2. The apparatus of claim 1, wherein the apparatus comprises a chemical reactor cell.

3. The apparatus of claim 2, wherein the chemical reactor cell comprises an electrochemical cell operative to generate at least one oxidizing agent by electro-oxidative reactions.

4. The apparatus of claim 3, wherein the electrochemical cell comprises at least one electrode pair and at least one electrolyte, and wherein the diffusion layer is present at an interface between each electrode of the pair and the electrolyte.

5. The apparatus of claim 1, wherein the at least one helicoidal baffle has a diameter configured to define a predetermined gap.

6. The apparatus of claim 1, wherein the at least one helicoidal baffle comprises at least one helicoid defined by a profile curve.

7. The apparatus of claim 1, wherein the at least one helicoidal baffle comprises at least one fin, the fin having a predetermined meridian thickness.

8. The apparatus of claim 1, wherein the at least one helicoidal baffle is configured with a handedness, the handedness comprising a right-handed helicoid or a left-handed helicoid.

9. The apparatus of claim 1, wherein the apparatus comprises at least two helicoidal baffles, the at least two helicoidal baffles being mirrored in pattern to have alternating handedness.

10. A method of removing and degrading at least one contaminant from a fluid stream, the method comprising:
introducing at least a portion of the fluid stream along at least one fluid path within an apparatus, the apparatus forming at least one surface defining a solid-fluid boundary, and having
at least one inlet for receiving the portion of the fluid stream as an input fluid stream,
at least one outlet for discharging the portion of the fluid stream as an output fluid stream, and
at least one helicoidal baffle positioned within the at least one fluid path and proximate to the at least one surface,
directing the at least one input fluid stream along the at least one helicoidal baffle to generate a vortex in the fluid stream, disrupting a diffusion layer at the at least one solid-fluid boundary, and
operating the apparatus to degrade the at least one contaminant, and
discharging at least a portion of the fluid stream from the apparatus as the output fluid stream.

11. The method of claim 10, wherein the solid-fluid boundary comprises an interface between at least one electrode surface and at least one electrolyte within the apparatus.

12. The method of claim 10, wherein the at least one helicoidal baffle comprises a diameter defining a predetermined gap.

13. The method of claim 10, wherein the at least one helicoidal baffle forms at least one helicoid defined by a profile curve.

14. The method of claim 10, wherein introducing the fluid stream along the at least one helicoidal baffle comprises directing the fluid through at least one helical channel having openings.

15. The method of claim 10, wherein the at least one helicoidal baffle is configured with a handedness, the handedness comprising a right-handed helicoid or a left-handed helicoid.

16. The method of claim 11, wherein introducing the fluid stream comprises controlling the flow rate to promote turbulence and enhance mixing at the solid fluid boundary.

17. Use of an apparatus comprising at least one inlet for receiving a fluid stream, at least one outlet for discharging the fluid stream, and at least one helicoidal baffle positioned proximate to a surface defining a solid-fluid boundary and within a fluid path, the at least one helicoidal baffle directing the fluid stream to generate a vortex that disrupts a diffusion layer at the solid-fluid boundary, for removing and degrading at least one contaminant from the fluid stream.

18. The use of claim 17, wherein the apparatus comprises a chemical reactor cell.

19. The use of claim 18, wherein the apparatus further comprises an electrochemical cell operative to generate at least one oxidizing agent at the solid-fluid boundary.

20. The use of claim 19, wherein the electrochemical cell comprises at least one electrode pair and at least one electrolyte, and wherein a diffusion layer is present at an interface between each electrode of the pair and the electrolyte.
